(19) United States
(12) Patent Application Publication
(10) Pub. No.: US 2014/0178084 A1
(43) Pub. Date: Jun. 26, 2014

(54) MACHINE LEARNING BASED TONE CONSISTENCY CALIBRATION DECISIONS

(71) Applicant: HEWLETT-PACKARD DEVELOPMENT COMPANY, L.P., (US)

(72) Inventors: Yan-Fu Kuo, West Lafayette, IN (US); George Henry Kerby, Boise, ID (US); Dennis Alan Abramsohn, Boise, ID (US); Jan Allebach, West Lafayette, IN (US); Jeffrey L. Trask, Boise, ID (US); George Tsu-Chih Chiu, West Lafayette, IN (US); Yuehwern Yih, West Lafayette, IN (US)

(73) Assignee: HEWLETT-PACKARD DEVELOPMENT COMPANY, L.P., Houston, TX (US)

(21) Appl. No.: 13/724,553

(22) Filed: Dec. 21, 2012

(51) Int. Cl. G03G 15/00

(52) U.S. Cl. CPC G03G 15/55
USPC 399/38; 399/44

(57) ABSTRACT

A method for making a tone consistency calibration timing decision includes measuring, with sensors and in conjunction with a first tone consistency calibration, a first state of a printer. A second state of the printer is also measured. A machine learning calibration module implemented by a computer processor determines if changes between the first state and second state justify a tone consistency calibration. If the changes between the first state and second state justify a second tone consistency calibration, then the second tone consistency calibration is performed.

### BACKGROUND

Printers produce a representation of an electronic data on physical media such as paper and transparency film. In printing, the tones produced by deposition of toner onto the media can change due to a number of factors including variations in operating conditions and media characteristics. Calibrations are performed to ensure consistent tone reproduction by the printer. The timing of calibration directly impacts color consistency. However, tone calibration consumes time and toner. Unnecessary calibration is not desirable because the calibration process can interfere with print operations and increase the cost of operating the printer.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of an electrophotographic printer, according to one example of principles described herein.

FIGS. 2A-2C are diagrams describing a decision-tree based calibration of a printer, according to one example of principles described herein.

FIG. 3 is a flowchart of printer data collection to generate a decision tree for tone consistency calibration, according to one example of principles described herein.

FIG. 4 is a flowchart showing training sample selection and composition, according to one example of principles described herein.

FIGS. 5 and 6 are diagrams of information entropies of data sample subsets in the training set, according to one example of principles described herein.

FIG. 7 is a diagram of field implementation of a decision-tree based calibration timing determination, according to one example of principles described herein.

FIG. 8 is a table describing two types of calibration errors produced by a decision tree, according to one example of principles described herein.

FIG. 9 is bar chart showing the tone differences produced by a printer operating at eight different temperature and humidity points, according to one example of principles described herein.

FIG. 10 shows graphs of false positive and false negative errors with different pruning ratios for each of four different colors of toner, according to one example of principles described herein.

FIG. 11 is a flowchart of a method for developing decision trees for tone calibration using cost ratios, according to one example of principles described herein.

FIG. 12 is a flowchart of a method for field implementation of decision-tree based calibration timing determination, according to one example of principles described herein.

FIG. 13 is a graph of calibration frequency verses cost ratio for decision-tree based tone calibration decisions, according to one example of principles described herein.

FIG. 14 is a chart showing the reduction in calibration frequency for a decision-tree based approaches, according to one example of principles described herein.

Throughout the drawings, identical reference numbers designate similar, but not necessarily identical, elements.

### DETAILED DESCRIPTION

In electrophotography, color reproduction is susceptible to variations in operating conditions. Calibrations are performed to ensure consistent tone reproduction. The timing of calibration directly impacts color consistency. Calibration consumes time and toner. Frequent calibration is not desirable. Determining appropriate calibration timing can maintain acceptable color consistency while minimizing consumable usage and print job interruption. The principles below describe a machine learning approach to determine calibration timing. In the approach, experiments are designed to collect tone measurements under various operating conditions. Decision trees are developed with these measurements using machine learning techniques. The resulting decision trees can be used to predict tone deviations and determine appropriate calibration action based on changes in operating conditions. Experimental results demonstrate that the principles described below can reduce the overall calibration frequency by approximately a third while maintaining desired tone consistency.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with the example is included in at least that one example, but not necessarily in other examples.

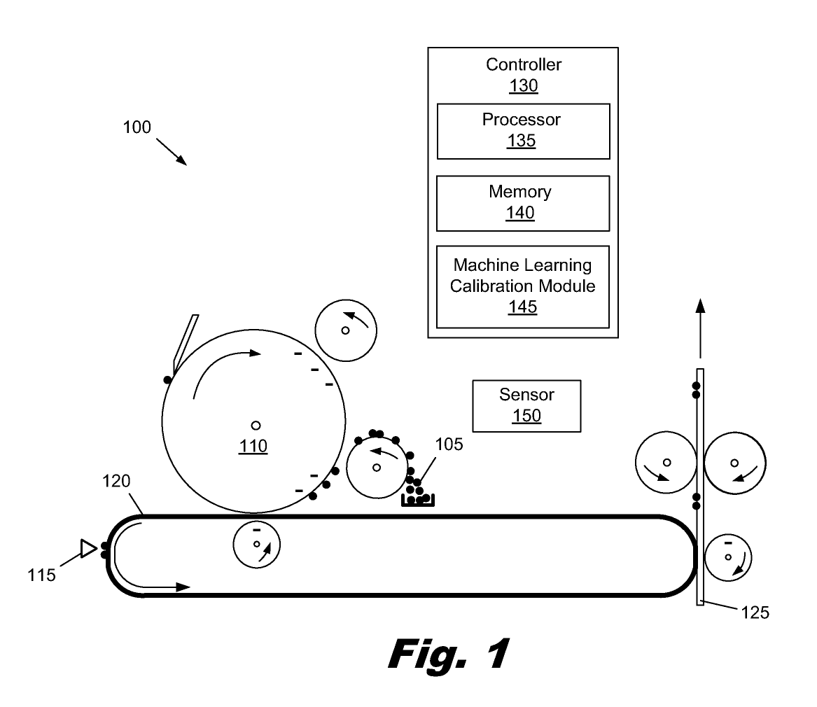

FIG. 1 is a diagram of an ElectroPhotographic (EP) printer (100) that creates images on media (125) by depositing toner (105) on the media. The printer (100) includes a photoconductive drum (110). In one implementation, the surface of the photoconductive drum (110) is electrostatically charged. The surface of the drum (110) is then exposed to laser light which discharges the electrostatic charges on selective portions of the drum. Areas with differential static charge (shown in FIG. 1 by minus signs near the surface of the drum) attract dry toner particles (105) to form an image. This image is transferred from the photoconductive drum to a transfer belt (120). The transfer belt (120) moves the image past an optical sensor (115). The optical sensor (115), when presented with appropriate calibration images, can determine if the printer is producing the desired tone consistency. Tone consistency refers to visual characteristics of an image when the desired amount of toner is present on a surface or substrate. The transfer belt (120) then transfers the image to media (125). The image is fused onto the media (125) using heat and/or pressure to ensure that the toner particles remain fixed on the media.

The operation of the printer is controlled by a controller (130). The controller (130) is typically integrated into the printer body but may also be separate from the printer. The controller includes a processor (135) and a memory (140). The memory (140) may include both volatile and non-volatile memory. The processor and memory may perform a variety of functions to control the printer operations and maintain the quality of the images the printer produces. In this example, the controller also includes a machine learning calibration module (145) that is implemented by the processor and memory. For example, the machine learning calibration module (145) may be a decision-tree based calibration.

For many different types of printers, color reproduction quality can be affected by changes in operating conditions, such as temperature, humidity, photoconductor drum age, usage, and throughputs. Calibrations are performed to maintain tone consistency under changing operating conditions. As described below, sensors (150) detect the state of the printer. For example, the sensor (150) may detect the temperature and relative humidity of the air inside the printer. The data values produced by the sensor (150) are output to the decision-tree based calibration module (145). The decision-tree based calibration module (145) accepts these data values and applies the data values to a decision tree. The decision tree outputs a binary tone consistency calibration decision that indicates if the data values justify performing a tone consistency calibration to adjust the color reproduction of the printer.

During a calibration, a number of color patches are printed on either transfer belts or output media and measured by an on-board optical sensor (115). Based on these measurements, calibration processes generate appropriate adjustments to printing process parameters, such as developer bias voltages, and rendering processes, such as tone correction, to maintain consistent tone reproduction. Calibrations cause job interruption and consume toner. Although desirable for maintaining tone consistency, frequent calibration increases cost of ownership and may negatively impact the customers' bottom line.

For most printing systems, calibration strategies are either reactive or preventive. Preventive calibrations are scheduled after a fixed number of printed pages or fixed amounts of time since last calibration, while reactive calibrations are initiated when undesirable outputs are observed. Preventive calibration is inefficient when a scheduled calibration is performed while the tone deviation is still within specification. Reactive calibration is inadequate due to the fact that an out-of-specification tone deviation has been observed. A more efficient and accurate calibration timing can decrease operation cost by reducing downtime and toner usage associated with calibration while maintaining desired tone consistency.

A number of machine learning methods can be used to determine appropriate calibration timing for printers. For example, artificial neural network, support vector machine, k-nearest neighbor, decision-trees and other machine learning techniques can be used. Below, a variety of decision-tree based approaches are described that determine appropriate calibration timing for color electrophotographic printers. The decision tree approach has a number of advantages including intuitive interpretation and relatively low computation requirements. The principles described herein could be used for a variety of printing technologies, including liquid and dry electrophotographic printers.

The implementation of appropriate calibration timing can be formulated as a decision-making problem. In the approach described below, experiments are designed to collect tone measurements on paper under various operating conditions. One or more decision trees are developed with these measurements using machine learning techniques. In one implementation, the inputs to the decision trees are operating conditions of the printer, such as temperature, humidity, cartridge age, toner usage, developer bias voltage, and changes in the operating conditions. These parameters define the printer state at a given time. The state of the printer is input into the decision tree, which outputs a binary calibration decision, to calibrate or not calibrate. For typical electrophotographic printers, on-board measurements of calibration color patches from transfer belts are only available during a calibration and are not included as decision tree inputs. During actual operation, the decision trees can predict appropriate calibration actions with only measurable operating conditions and no tone measurements are needed.

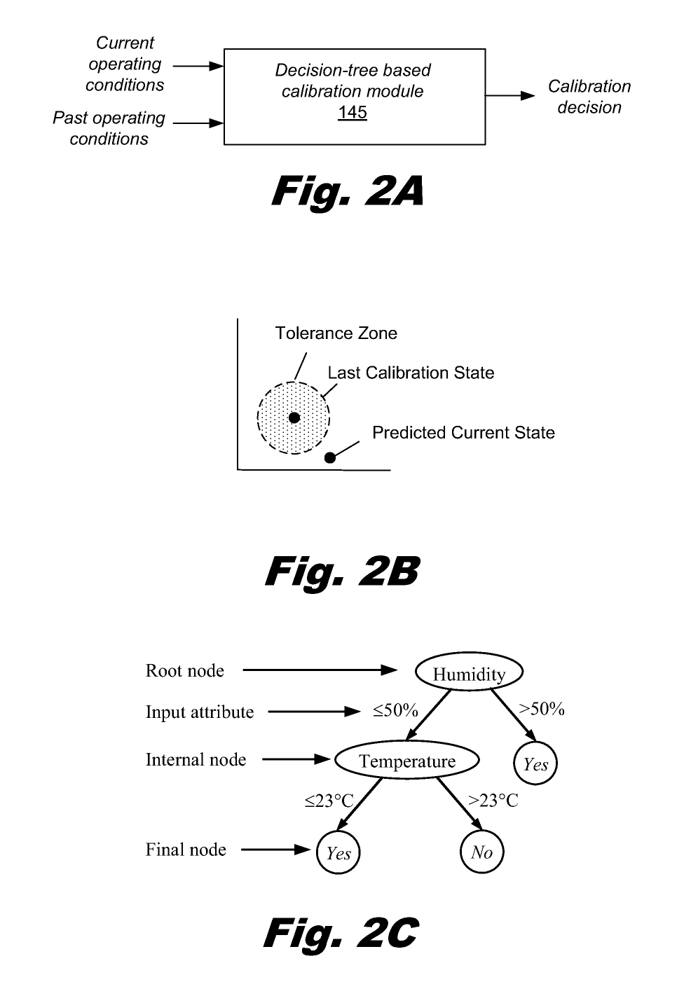

FIG. 2A shows the decision-tree based calibration module (145) with two inputs: past operating conditions (a first printer state) and current operating conditions (a second printer state). The decision tree used by the calibration module accepts these inputs and determines if the changes in the operating state of the printer justify performing a calibration. The calibration module (145) outputs a calibration decision.

FIG. 2B shows a simplified graph describing this decision making process. The last calibration state is presumed to be valid within a tolerance zone (illustrated by the dashed circle). If the predicted current state of the printer is within the tolerance zone, no calibration action is taken. However, the predicted current state is outside of the tolerance zone, the calibration module determines that a tone consistency calibration should be performed. The tolerance zone is captured by structure and thresholds in the decision tree. The decision tree can define the tolerance zone using multiple dimensions/parameters.

The description below is organized as follows. Decision tree predictor is introduced in the next section followed by a detailed discussion of the problem formulation and the development of the decision-tree based approach. Experiment design and data processing for developing the decision tree predictor and numerical simulation to compare the decision-tree based approach with a historical approach are described in the fourth section. The final section includes concluding observations and remarks.

### Decision Trees

Decision trees are empirical predictors that can be used to determine appropriate maintenance actions of a device/process for given events. For example, decision trees can be used to determine performing calibration or not for given changes in temperature, humidity, and/or cartridge life. Decision trees are constructed by machine learning techniques. These techniques iteratively create a sequence of if-then-else tests arranged as nodes in a tree structure. FIG. 2C shows one example of a decision tree that includes a root node, internal nodes, and final nodes. Each internal node (including the root node) of the tree represents a test associated with an input attribute, e.g., temperature. At a decision point in time, the input attribute values are measured and fed into the decision tree. Tests are performed in the tree nodes, starting from the root node and ending when the process reaches one of the final nodes. In each test, the current value of an input attribute specified by the test is compared with the node branching value to select the branch for advance. By branching forward throughout the tree until a final node is met, the best calibration action is asserted and applied. Note that, during proceeding along the tree branches, not all input attributes are necessarily to be checked throughout the process. As shown by the very right branch in FIG. 2C, the input attribute temperature is not checked. The final node (“No” or “Yes”) is the output of the calibration module (145) and indicates whether or not a calibration action should be taken.

### Methods

Let x(t)=[xᵢ(t)]ε [symbol] ^{m} denote a set of operating conditions of an electrophotographic printer at a point in time tε [symbol] , and y(t)=[yᵢ(t)]ε [symbol] ⁿ denote the measured tone values at a set of pre-determined halftone levels. Suppose the electrophotographic system is calibrated at a previous time t₁. As time goes by, the operating condition varies from x(t₁) to x(t₂), where t₂ is current time and t₂>t₁. Consider the change in operating condition results in tone deviation Δy(t₂, t₁)=[Δyᵢ(t₂, t₁)]≡y(t₂)−y(t₁)ε [symbol] ⁿ, where each Δyᵢ corresponds to a pre-determined halftone level. At the current time t₂, a calibration is necessary to bring the output tone value back to desired target if some metrics of the tone deviation Δy is larger than a threshold; otherwise, no action may be taken. The objective of this work is to develop a decision making module f in the form of a decision tree that determines appropriate calibration action at the current point in time t₂ with given the current and past operating conditions as inputs to the decision tree, i.e.,

c=f(x(t₂),x(t₁)), Eq. 1

where cε{calibration, no calibration} is a calibration action. Note that alternative decision tree inputs can be used. Denote Δx(t₂, t₁)=[Δxᵢ(t₂, t₁)]≡x(t₂)−x(t₁) ε [symbol] ^{m} as the difference between the two operating conditions measured at the current time t₂ and past time t₁. Eq. 1 can be re-formulated as

c=f(x(t₂),Δx(t₂,t₁). Eq. 2

In the implementation discussed below, a separate decision tree is developed for each primary color. Assuming interactions between primary colorants are minimal, the same procedure can be applied to all primary colors since each of them is reproduced independently on in-line color electrophotographic printers. The decision tree development process composes four steps—experiment design and data collection, training sample composition, decision tree growth, and decision tree pruning.

### Experiment Design and Data Collection

Experiments are designed to collect data for decision tree development. Controllable electrophotographic variables, measurable environmental parameters, and consumable factors that are significant to electrophotographic process performance are selected as control variables. Typical control variables can include developer bias voltage, temperature, humidity, usage duty cycle, or cartridge life. Note that on-board color patch measurements are not included as control variables since they are only available during calibration. In the experimental design, the setup points of each control variable should cover a broad range of conditions encountered in typical customer usage.

The data collection procedure is illustrated in FIG. 3 and proceeds as follows. During an experiment, electrophotographic printers are operated under a controlled condition x. Automatic tone correction and calibration processes in the printers are bypassed. Once steady operating condition is reached, primary color patches are printed on output media. The corresponding tone value y is measured off-line using a calibrated instrument, such as a spectrophotometer. The tone value y and its corresponding operating condition x is collected and recorded in a database.

### Training Sample Composition

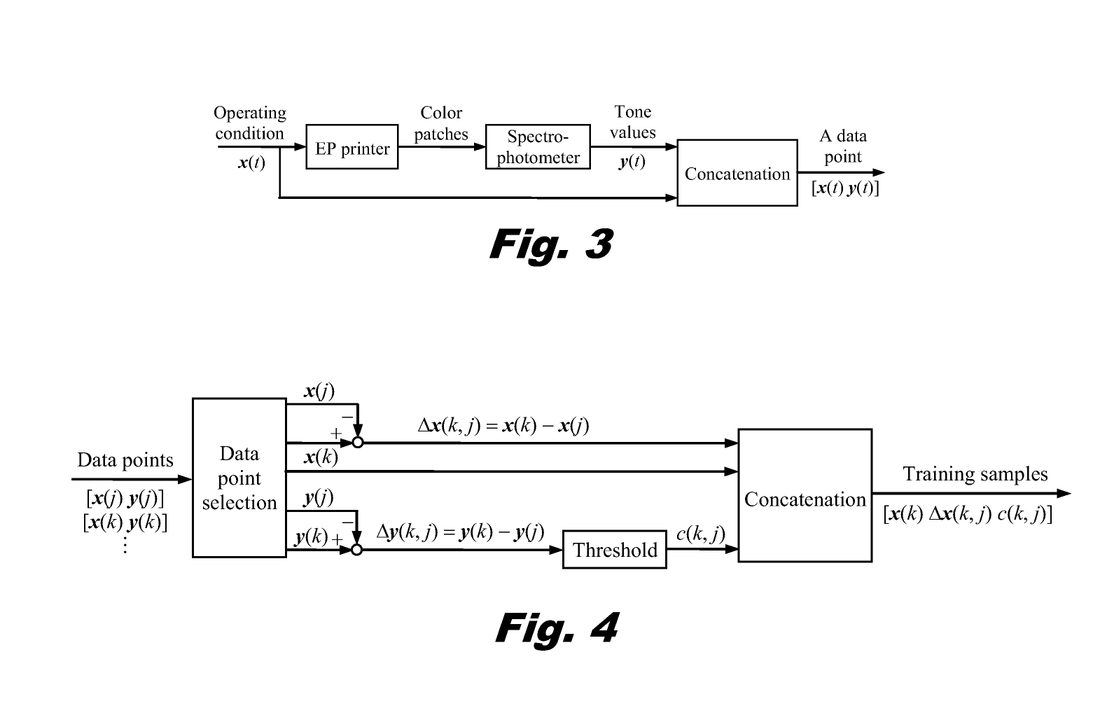

Training samples for decision tree development are composed from the data points collected under different conditions. Two data points [x(tₖ) y(tₖ)] and [x(tⱼ) y(tⱼ)], where tₖ>tⱼ, are selected from the database. For simplicity, the variables can be rewritten with x(tₖ) as x(k), and y(tₖ) as y(k). The point [x(k) y(k)] represents current operating condition (a second printer state) and tone value, and the point [x(j) y(j)] represents operating condition and tone value at a previous calibration (a first printer state). A training sample is composed of the current operating condition x(k), the difference between the two operating conditions Δx(k, j), and calibration action c(k, j). The calibration action c(k, j) is determined by comparing the absolute weighted mean tone deviation | Δ̅y̅(k, j)|_{w} to a threshold δε [symbol] , i.e.,

$$c ( k , j ) = \{ \begin{matrix}{c}_{1} , & {\vert \overline{Δ y} ( k , j ) \vert}_{w} > δ \\ {c}_{2} , & {\vert \overline{Δ y} ( k , j ) \vert}_{w} \leq δ\end{matrix} \qquad Eq . 3$$

where c₁ and c₂ represent the class label “calibration” and “no calibration,” respectively. The absolute weighted mean tone deviation is defined as

$${\vert \overline{Δ y} \vert}_{w} ≡ \vert \frac{{\sum }_{i = 1}^{n} {w}_{i} Δ {y}_{i}}{{\sum }_{i = 1}^{n} {w}_{i}} \vert ∈ ℛ , \qquad Eq . 4$$

where w=[wᵢ]ε [symbol] ⁿ is a weighting vector. Each entry in w corresponds to a unique halftone level. Larger entry values can be assigned in wᵢ to further penalize the tone deviation Δyᵢ at the corresponding halftone levels. The threshold δ is usually determined based on tone consistency requirement and performance limitation of electrophotographic printers. FIG. 4 illustrates the flowchart of training sample composition. Note that, in Eq. 3, the weighted norm of tone value difference can be compared to two or more thresholds to generate multiclass labels if a scheme of more complex calibration action determination is needed.

Restrictions may be applied to screen out training samples that are not applicable under normal operations. For example, in typical customer usage, cartridges are used until the end of their lives. The selected data sample pairs should be as well. Data points that are not from the same cartridge are not included in the training samples. The training sample composition and selection proceed until all the possible combinations of data points have been examined.

### Decision Tree Growth Techniques

Decision trees are developed starting from the root node with the training samples in a top-down manner. In each training sample, the entries of the current operating condition xᵢ and the entries of the difference between the two operating conditions Δxᵢ are attributes. The calibration action c is the class label. The main task in the decision tree growth is to recursively find an appropriate attribute for each test (internal node) with which the training samples are split into subsets. For example, the decision tree growth may be formulated using C4.5 machine learning technique. The C4.5 machine learning technique is described in a number of references, including J. R. Quinlan, C4.5: Programs for Machine Learning (Morgan Kaufmann Publishers, San Francisco, Calif., 1993). C4.5 evaluates attributes based on information entropy. Let D denote a set of training samples. Suppose there exists qεN different possible (calibration action) classes cᵢ, where i=1, . . . , q. The information entropy h(D)ε [symbol] of the set D is defined as

$$h ( D ) ≡ - {\sum }_{i = 1}^{q} p ( D , {c}_{i} ) \cdot {log}_{2} ( p ( D , {c}_{i} ) ) , \qquad Eq . 5$$

where p(D,cᵢ)ε [symbol] denotes the proportion of samples in the set D that belong to the class cᵢ, and

$${\sum }_{i} p ( D , {c}_{i} ) = 1.$$

The information entropy is a measure of randomness of the sample class in a set. A smaller information entropy indicates that a larger majority of the samples in the set belong to the same class. Note that the information entropy is always non-negative. When all the samples in a set belong to a single class, there is no uncertainty and the information entropy is zero.

A test on an effective attribute should reduce the overall information entropy of the split subsets. C4.5 evaluates all the attributes and chooses the one that gives the maximum reduction in information entropy. Let αε{xᵢ, Δxᵢ} denote an attribute. Consider α as a discrete-valued attribute with rεN different values, i.e., α=α₁ . . . , αᵣε [symbol] . Usually r is a small number. A test on α partitions the set D into mutually excluded subsets D₁, . . . , Dᵣ, where Dᵢ is the subset of training samples associated with attribute value αᵢ. The weighted sum of information entropies over the subsets for the attribute α is defined as

$$h ( D , α ) ≡ {\sum }_{i = 1}^{r} \frac{{d}_{i}}{d} \cdot h ( {D}_{i} ) \qquad Eq . 6$$

where dᵢεN denotes the number of training samples in the subset Dᵢ, and

$$d = {\sum }_{i} {d}_{i} ∈ N$$

denotes the number of training sample in the set D. Information gain g(D,α)ε [symbol] for the test on the attribute α is defined as the reduction in information entropy, i.e.,

g(D,α)≡h(D)−h(D,α)ε [symbol] . Eq. 7

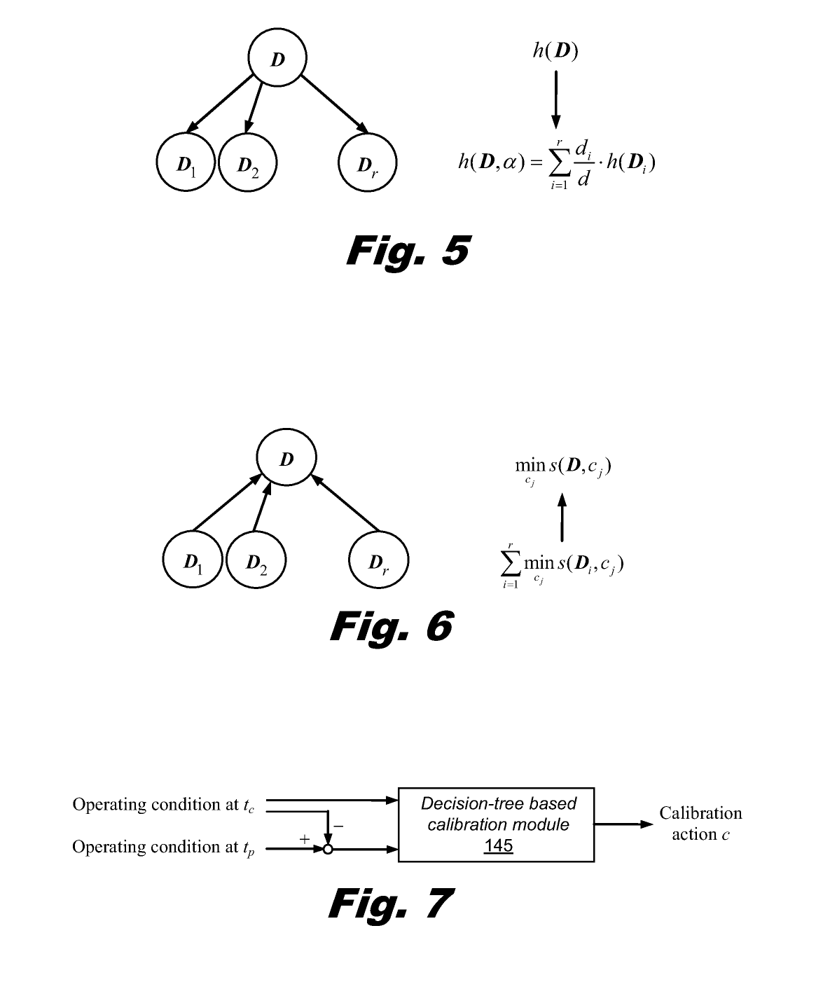

The information entropies before and after a test on the attribute α are graphically illustrated in FIG. 5.

Using the information gain to assess continuous-valued attributes may include consideration of several different aspects. Continuous-valued attributes can be potentially associated with an infinite number of different values, i.e., r˜∞. The information gain in Eq. 7 factors in attributes with larger numbers of different values. Instead of splitting samples into infinitely many subsets, C4.5 partitions the set D into two subsets, i.e., r=2 in Eq. 6, for a continuous-valued attribute using an appropriate threshold. Suppose α is a continuous-valued attribute. Different values of α are first sorted in an ascending order, i.e., α₁, . . . , αᵣ, where αᵢ<αᵢ₊₁. C4.5 considers the median of every two consecutive values as a threshold candidate ρᵢ=(αᵢ+αᵢ₊₁)/2ε [symbol] , where i=1, . . . , r−1. For each continuous-valued attribute, information gains for all the possible thresholds ρᵢ are calculated following Eq. 7. Then the threshold that gives the maximum information gain is chosen for the attribute α.

C4.5 calculates the information gains for all the possible attributes and chooses the one that gives the maximum gain. Once the attribute is determined, the data set is split into subsets accordingly. Then C4.5 recursively apply the same machinery to each subset of partitioned training samples until some stop criteria is reached. The stop criteria may include 1) all the samples in the subset belong to the same class, 2) all the samples in the subset are associated the same attribute values, 3) a minimum number of samples in the subset, and 4) entropy cannot be further reduced. Once the growth stops, the decision tree output class c at a final node associated with a sample subset D is the calibration action that are associated with the majority of the training samples in D, i.e.,

$$c = arg {max}_{{c}_{i}} p ( D , {c}_{i} ) \qquad Eq . 8$$

Note that C4.5 is a greedy technique. It determines the optimal choice of attribute for each node with the assumption that the collection of the optimal choices of all the nodes is the global optimum. Although the C4.5 technique is used to provide a detailed example of one method for constructing an initial decision tree, a variety of other machine learning techniques could also be used.

### Decision Tree Pruning Techniques

The decision tree built in the growth stage can be complex due to noise in the training data set. The goal of the prediction, however, is to determine appropriate calibration action for unseen cases. Pruning mechanism improves the performance of decision trees by removing cases of over fitting. The pruning process includes defining a subtree as a branch of a fully developed decision tree associated with one internal node and some final nodes. Pruning processes check the decision tree from bottom to top to determine whether or not a subtree should be replaced with a final node. This is graphically illustrated in FIG. 6, which shows minimum costs before and after pruning a substree.

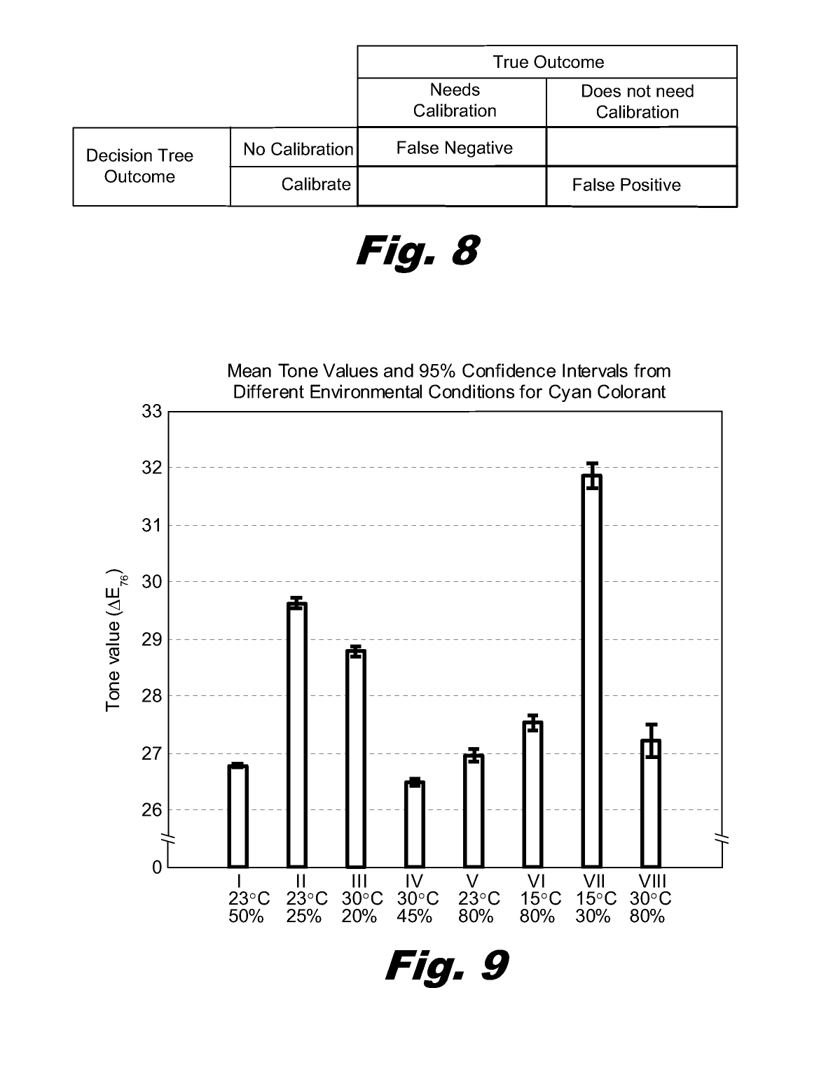

There are a variety of methods that can be used to prune decision trees. Some of these methods are designed to minimize error rates of decision trees. The decision tree prediction errors are associated with different costs or penalties. For example, a decision tree prediction error may be a false negative calibration decision. A false negative error is defined as a mis-prediction that fails to perform a calibration when a calibration is needed (i.e. the tone deviation is actually larger than the calibration threshold, but a calibration is not performed). Another type of predication error is a false positive error. A false positive error is defined as a mis-prediction that fails to restrain a calibration when a calibration is not needed (i.e. the tone deviation is actually smaller than the calibration threshold, but a calibration is performed anyway). FIG. 8 shows a table with a summary of false negative and false positive errors. From the color consistency point of view, the false negative error leads to undesired tone variation and should be prevented. On the other hand, if consumable economy is the top priority concern, the false positive error should be avoided. The cost of a false negative error can be substantially higher or lower than that of a false positive error, depending on each scenario.

A cost based pruning process is applied in this work to provide a way for trading-off between different error costs. Let o(cⱼ, cₖ)ε [symbol] denote the misclassification cost (or penalty) of falsely predicting a single sample as the class cⱼ when in fact it belongs to the class cₖ, where o(cⱼ, cₖ)>0 if j≠k and o(cⱼ, cₖ)=0 otherwise. The cost s(Dᵢ, cⱼ)ε [symbol] of using the class cⱼ as the output at a final node associated with a training sample subset Dᵢ is

$$s ( {D}_{i} , {c}_{j} ) = {d}_{i} \cdot {\sum }_{k = 1}^{q} o ( {c}_{j} , {c}_{k} ) \tilde{p} ( {D}_{i} , {c}_{k} ) , \qquad Eq . 9$$

where \tilde{p}(D₁,cₖ)ε [symbol] is the Laplace-corrected proportion of training samples that belong to the class cₖ in the subset Dᵢ. The Laplace correction makes the training sample proportion more uniform and less extreme. It is defined as:

$$\tilde{p} ( {D}_{i} , {c}_{k} ) = \frac{p ( {D}_{i} , {c}_{k} ) \cdot {d}_{i} + 1}{{d}_{i} + q} . \qquad Eq . 10$$

The minimum cost at a final node associated with the subset Dᵢ is:

$${min}_{{c}_{j}} s ( {D}_{i} , {c}_{j} ) . \qquad Eq . 11$$

Pruning is performed when replacing a subtree with a final node reduces the cost. Suppose a subtree associated with r final nodes is examined (see FIG. 6). Each of the final nodes is associated with a sample subset Dᵢ. If the subtree is pruned, the subsets are combined to form a set D, i.e.,

$$D = {⋃}_{i} {D}_{i} .$$

The subtree is pruned if the minimum cost after pruning is smaller than that before pruning, i.e.,

$${min}_{{c}_{j }} s ( D , {c}_{j} ) < {\sum }_{i = 1}^{r} {min}_{{c}_{j}} s ( {D}_{i} , {c}_{j} ) . \qquad Eq . 12$$

The procedure continues until any further pruning does not reduce the cost. Then the output class c at a final node associated with a sample subset D is the calibration action that gives the minimum cost, i.e.,

$$c = arg {min}_{{c}_{j}} s ( D , {c}_{j} ) . \qquad Eq . 13$$

Note that when misclassification costs are equal for all type of errors, minimizing the cost is equivalent to minimizing the prediction error. In this special case, the class c from Eq. 8 is identical to the class c from Eq. 13.

### Operational Implementations

Once the decision trees are developed, they can be implemented on printers in the field to determine appropriate calibration timing using only the printer operating conditions as inputs. During the implementation, the operating condition x(tₚ) at a time of a previous calibration tₚ is stored. Whenever a calibration decision point at time t_{c} occurs, the printer measures the most recent operating condition x(t_{c}) and calculates the difference between the two, Δx(t_{c}, tₚ). Then the information is fed to the decision tree to determine the appropriate calibration action. This field implementation of the decision-tree based calibration timing approach is graphically illustrated in FIG. 7. In some implementations, the decision points may be set to occur after print jobs are finished, so interference to customer usage can be minimized. Time t_{c} is an appropriate time if the decision trees' output is “calibration”. Note that the decision trees may be stored in an alternative form, e.g., look-up tables, when desirable.

### Experiment

The decision-tree based calibration timing determination approach described above was performed on an off-the-shelf in-line color electrophotographic printer model. Automatic calibration and tone correction functions in the printers were disabled during the experiment to prevent the resulting tone variation. The operating condition x includes developer bias voltage (DBV), cartridge life remaining (CLR), relative humidity (RH), and temperature (T). The developer bias voltages are denoted in percentage between 0 and 100%, where 0% represents the lowest admissible voltage and 100% represents the highest admissible voltage. The CLR ranges between 0 and 100%, where 0% represents an empty cartridge and 100% represents a new one.

The operating condition setup points for the experiment to measure tone consistency as a function of operating parameters are described below. The experiment was performed with four developer bias voltage setup points at 0%, 33%, 66%, and 100% of the admissible voltages. Eight different temperature and relative humidity set points that cover the range of environmental condition (15 to 30° C. and 30 to 80% RH) in typical customer usage were chosen. The number of environmental condition points in the current experiment was limited by the available budget. More temperature and relative humidity set points may be included in the experiment design to provide further comprehensive data for decision tree development if desired.

In typical customer usage, the environmental or consumable condition of electrophotographic printers usually does not change dramatically in a short period of time. The experiment design focuses on observing tone deviation particularly due to local condition changes. The eight environmental setup points are put into four sets with repetition, each of which contains a few neighboring temperature and relative humidity points (see Table I). The experiment then proceeded set by set. Within each set, the temperature and relative humidity were changed from one point to another following a specified order. Each set is repeated five times to collect data with various CLRs (Cartridge Life Remaining) before the experiment moves to next set.

TABLE I
Sets of temperature and humidity setup points.

| | Temperature and relative humidity |
|---|---|
| Set | setup points and their order |
| A | I → II → III → IV |
| B | I → V → VI |
| C | I → II → VII → VI |
| D | I → V → VIII → IV |

Primary color patches are printed at each temperature and relative humidity set point to provide tone values. The printers were first fully acclimated for several hours under each temperature and relative humidity condition. Then a few dozen warm-up pages were printed to prevent the effect of transient tone value fluctuation. These pages are chosen from a variety of different sample text or graphic images to simulate typical customer usage. After that, test pages each of which consists of seventeen primary color patches at halftone levels [15, 30, . . . , 255] for each primary color are printed. In this work, a halftone level is represented by a unitless 8-bit integer, where 0 represents no colorant and 255 represents the maximum amount of colorant. The test pages are printed at the four pre-determined developer bias voltages for five repetitions following a pseudo-random order. After the test pages, more pages are printed at each temperature and relative humidity set point until the cartridge life remaining (CLR) indicator is decremented by 1%. This allows testing of tone consistency at each level of CLR. After performing the tone consistency tests at this set point, the environmental conditions are changed to the next set point and the printer is again acclimatized.

The calibration test pages produced by the printer were measured with a spectrophotometer (X-Rite® DTP-70) using D65 illuminant and 2° observer. In this example, the term “tone value” is defined as the Euclidian distance in CIE L*a*b* space between the measured color and the substrate appearance color, so that a larger tone value appropriately corresponds to a larger amount of colorant. A 75-g/m² commercial white paper (Xerox® 4200 Business) is used as the output media. Tone value may be defined in a variety of other ways and in conjunction with different color spaces. The experiment was performed on four sets of cartridges with different amounts of cartridge life remaining. A total of 2,642 test pages (data points) were collected. “Tone value” could also be measured using a variety of other techniques including CIE 1976 (L*, a*, b*) color space. The difference between CIE L*a*b* space (Hunter L,a,b space) and CIE 1976 L*a*b* space is that the CIE L*a*b* coordinates are based on a square root transformation while CIE 1976 L*a*b* coordinates are based on a cube root transformation.

### Tone Variation as a Function of Environmental Condition Set Points

FIG. 9 is a graph that shows mean tone values for a single cyan cartridge and their 95% confidence intervals at halftone level 135 under the eight different environmental conditions. The data demonstrates the existence of tone variation due to changes in environmental condition. The tone deviation can be as large as 5 ΔE units if the ambient condition of the printer changes from 23° C. and 50% RH (setup point I) to 15° C. and 30% RH (setup point VII). In contrast, the tone deviation can be minimal if the ambient condition changes from 23° C. and 50% RH (setup point I) to 30° C. and 80% RH (setup point VIII). The tone variation over the T and RH setup points is not uniform. The change in tone values as a function of temperature and relative humidity can be due to a number of factors, including changes in the electrical characteristics of air and the print media as a function of the amount of water vapor present in the air.

### Decision Tree Development

Training samples are composed from the experimental data following the procedure below. Because the experiment is performed from set to set, pairs of data points are selected only if they are from the same set of T and RH setup points. Note that this restriction results in that the maximum difference in CLR of the training samples is 20%. This is because there are up to four T and RH setup points in each set and the experiment is repeated five times on each set. During the composition, the (calibration action) class labels for the training samples are determined by following Eq. 3. The weighting vector w is chosen to be a vector where wᵢ=1 if i=6, . . . , 11 and wᵢ=0 otherwise. The halftone color patches have minimal variability in the highlight or shadow areas due to the halftone-induced tone curve distortion and the limited available dynamic range in these portions of the tone scale. Consequently, the halftone color patches are neglected in the absolute weighted mean tone deviation. A threshold δ of 3 ΔE units is used to determine the class labels. This threshold is chosen based on the maximum calibration error of the tested electrophotographic platform.

Decision trees are developed with the composed training samples. During the tree growth, the developer vias voltage, CLR, and difference in CLR are considered as continuous-valued attributes. The difference in temperature and relative humidity are considered as discrete-valued attributes because of the limited number of environmental set points included in the experiment. The decision trees are pruned with several different cost ratios for comparison purposes. The pruning cost ratio is defined as the cost of false negative error over the cost of the false positive error, i.e., o(c₂, c₁)/o(c₁, c₂). The calculation of the decision tree development was made using Matlab®.

### Decision Tree Accuracy Test

A test experiment was performed to check the accuracy of the developed decision trees. The data points for validation in the accuracy tester were collected following the same procedure used to collect data for creating the decision trees, but a different set of toner cartridges were used. A total of 790 data points were collected. The resulting test samples are fed into the developed decision trees to check the accuracy of the decision trees in determining if a tone consistency calibration should be performed.

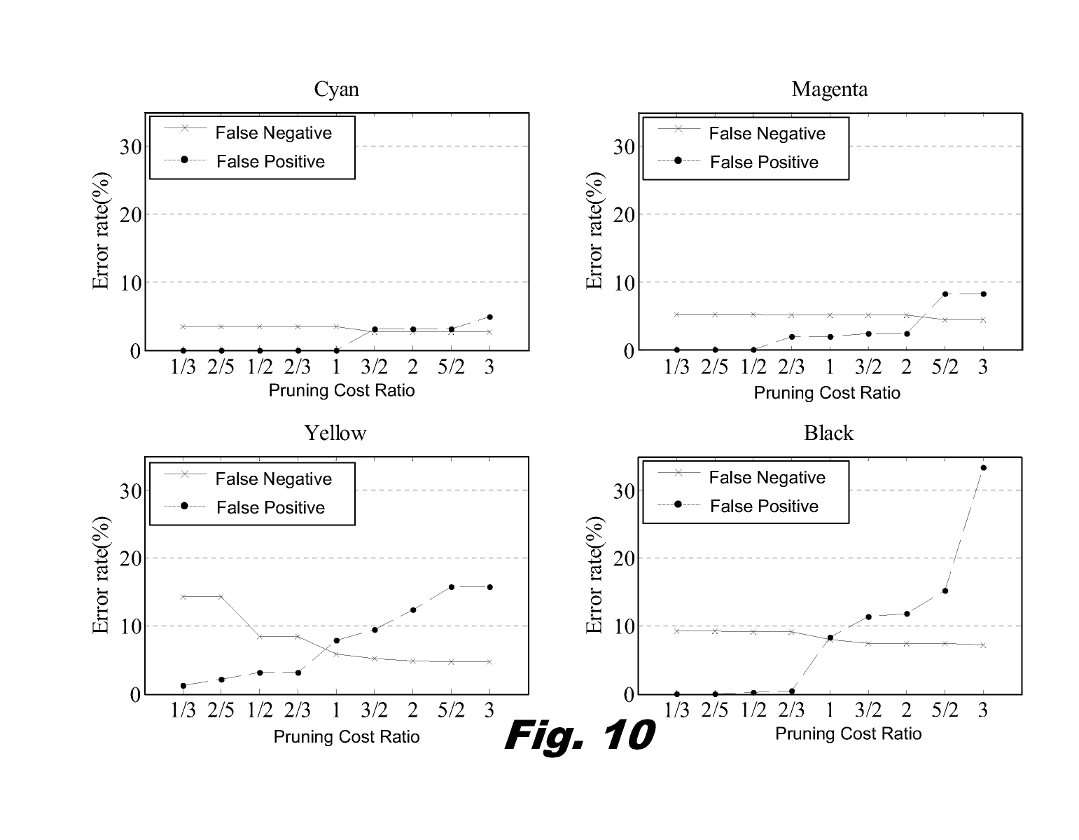

FIG. 10 displays the false negative and positive error rates against different pruning cost ratios for the four primary colorants: cyan, magenta, yellow, and black. The error rate is shown on the vertical axis of the graphs and ranges from 0 to 35%. The cost ratio is shown on the horizontal axis of the graphs and ranges from ⅓ to 3.

In general, the false negative error can be reduced to within 8% with larger pruning cost ratios. However, the false positive error rates can be substantially increased and results in unnecessarily frequent calibration when cost ratios are large (see black colorant at cost ratio 3). The pruning cost ratio provides a way to trade off between color consistency and consumable economy.

### Method Flow Charts

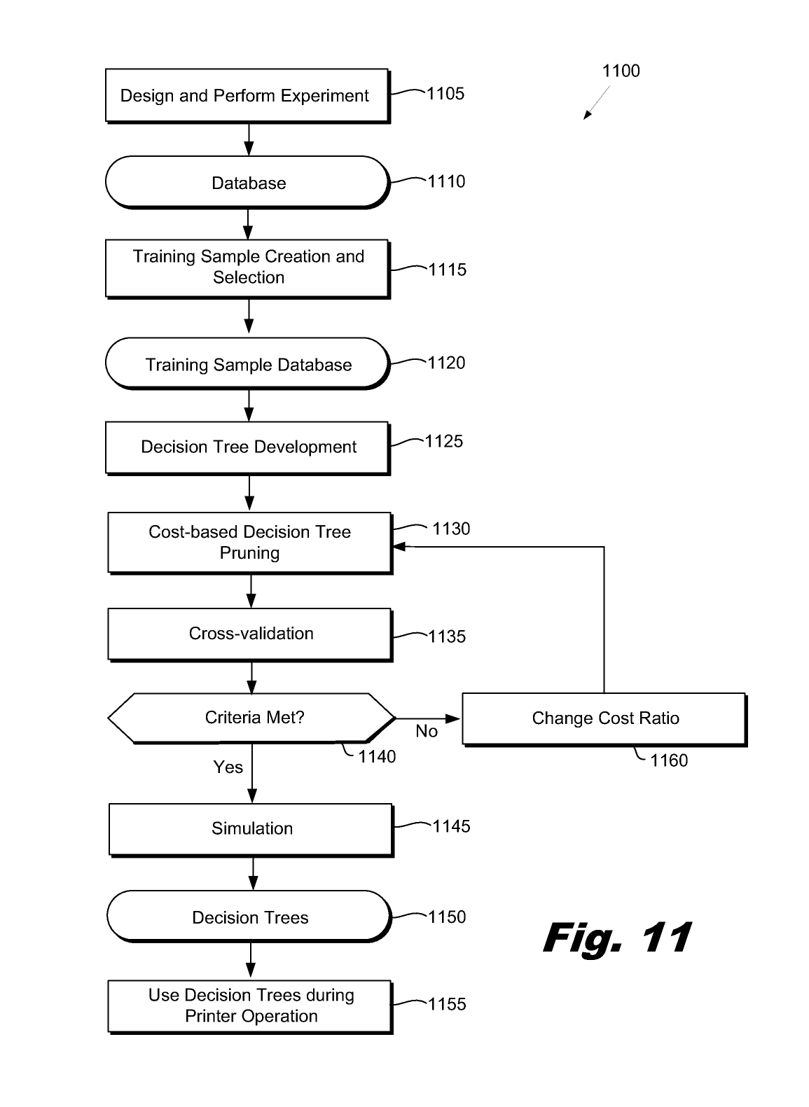

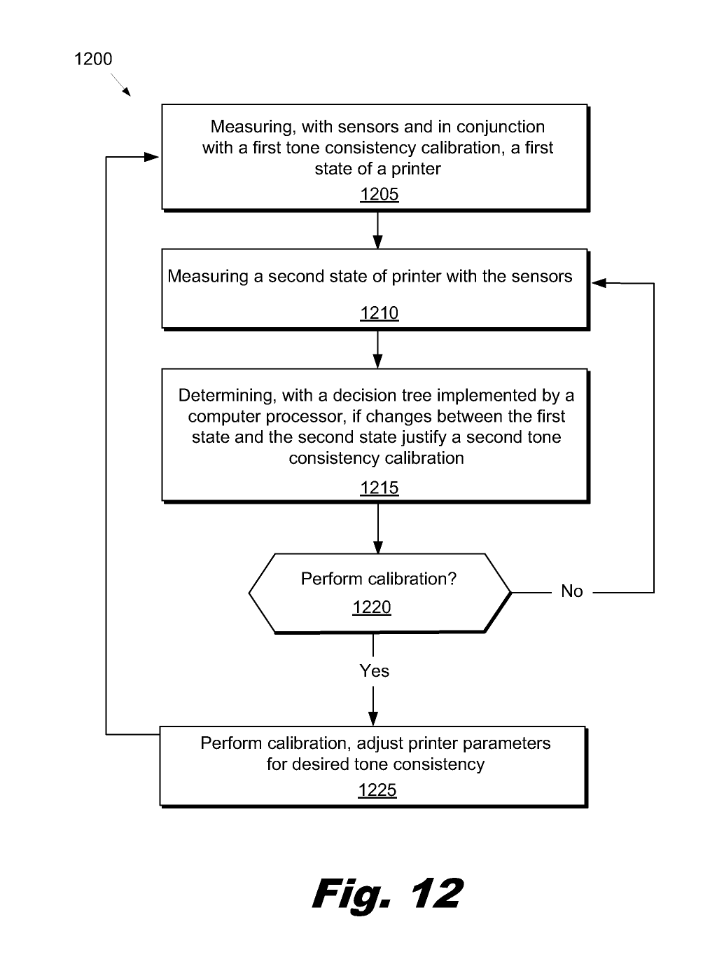

FIGS. 11 and 12 are flowcharts that describe the principles discussed above. FIG. 11 is a flowchart of a method (1100) for creating and testing decision trees for making tone consistency calibration decisions. The experiment is designed and performed (1105) to generate data points describing the tone consistency characteristics of similar printers. Examples of similar printers include printers in the same model family or printers with the same model number. As discussed above, the experiment may be designed to test printers over a range of operating conditions and printer states. A database capturing the data points collected during the experiments is created (1110). The training samples are selected (1115) and stored in a database (1120) or other data structure. The unpruned decision tree is then developed as described above (1125). The unpruned decision tree is pruned based on a cost (1130). For example, the cost could be a cost ratio of false negative and false positive errors. Cross-validation of the pruned decision trees is performed using data that was not used in the decision tree development (1135). A decision is made to determine if the pruned decision trees meet predetermined criteria (1140). For example, the desired criteria may be a maximum allowable deviation in the tone consistency of the printer and/or a desired reduction in the number of calibrations. If one or more of the criteria are not met (1140 “No”) then the cost ratio is changed (1160) and the cost based pruning of the original decision trees is again conducted. If the criteria are met (1140 “Yes”) then the process proceeds and a simulation (1145) or other validation is conducted and the final decision trees (1150) are stored for use during operation of applicable printer models (1155).

FIG. 12 is a flowchart of an illustrative method (1200) for using decision trees to make a decision-tree based tone consistency calibration timing decision. A first state of the printer is measured, with sensors and in conjunction with a first tone consistency calibration (1205). The calibration may be an initial calibration triggered by insertion of a new print cartridge or calibration that is triggered by the decision-tree based calibration module. The measured state of the printer may include one or more of: environmental temperature, an internal printer temperature, relative humidity, absolute humidity, number of pages printed, time since last printing, toner levels, remaining toner cartridge life, or other applicable parameter. The first state may be measured by a variety of sensors that are onboard the printer or are external to the printer.

At some later time, a second state of the printer is measured with the sensors (1210). A decision tree implemented by a computer processor is used to determine if changes between the first state and second state justify a second tone consistency determination (1215). The decision tree makes the decision to perform a calibration or not (1220). If the changes in the parameters is not great enough to justify performing a calibration (1220, “No”) then the process returns to block 1210 and re-measures a second state of the printer at a later time. The process then continues. The second state measurements may be made continuously, at predetermined intervals, or may be triggered by various printing events or parameters. For example, the state of the printer may be measured every minute during operation. Additionally or alternatively, the state of the printer may be measured: at the end or beginning of a print job, after a given number of pages have been printed, or after a predetermined amount of toner has been consumed. The sensors making the state measurements may be located internally to the printer or, in some cases, may be external to the printer.

If the decision-tree based calibration module determines that a second tone consistency calibration should be performed (1220 “Yes”) then the calibration is performed and printer parameters (such as developer voltage levels) are adjusted to achieve the desired tone consistency. The calibration may not occur immediately following the determination that calibration should be made. For example, the calibration may be performed after a print job has been completed. This can minimize operational disruptions. However, if the print job is large or the predicted deviation in the tone consistency is large, the printer may stop the print job, perform the calibration and then resume the print job.

After the calibration is performed, the process continues back to block 1205 and the first state of the printer is re-measured and stored for later retrieval.

### Calibration Frequency Reduction

To measure the reduction in calibration frequency produced by the decision trees, the calibration frequency produced by the decision-tree based calibration module was compared to historic printer usage data from a print quality project conducted at Purdue University. This printer usage data is described in C.-L. Yang, Y.-F. Kuo, Y. Yih, G. T.-C. Chiu, D. A. Abramsohn, G. R. Ashton, and J. P. Allebach, “Improving tone prediction in calibration of Electrophotographic printers by linear regression: environmental, consumables, and tone-level factors,” J. Imaging Sci. Tech. 54: 050301 (2010).

In the Purdue project, printers were located under typical office environments. Their operating conditions were collected every few hours and were stored in a database. The simulation is conduced with the data collected on a printer between November 2005 and October 2006. The printer produced more than 180,000 pages with 15 sets of cartridges during this period.

The calibration criteria of the decision-tree based and historical calibration timing determination techniques are as the follows. The decision-tree based process triggers a calibration whenever a new cartridge is inserted, whenever the output of any primary color decision tree indicates that calibration should be performed or whenever any cartridge is consumed for 20% in their CLR since a previous calibration. The last criterion for the decision-tree based process is given because the maximum CLR difference of the training samples is 20%. Any unseen cases with CLR difference larger than 20% are beyond the knowledge stored in the decision trees; hence a calibration should be enforced. The historical process triggers a calibration whenever a new cartridge is inserted or whenever any cartridge is consumed for 10% in their CLR since a previous calibration. Note that the historical process does not consider tone variation due to changes in environmental condition.

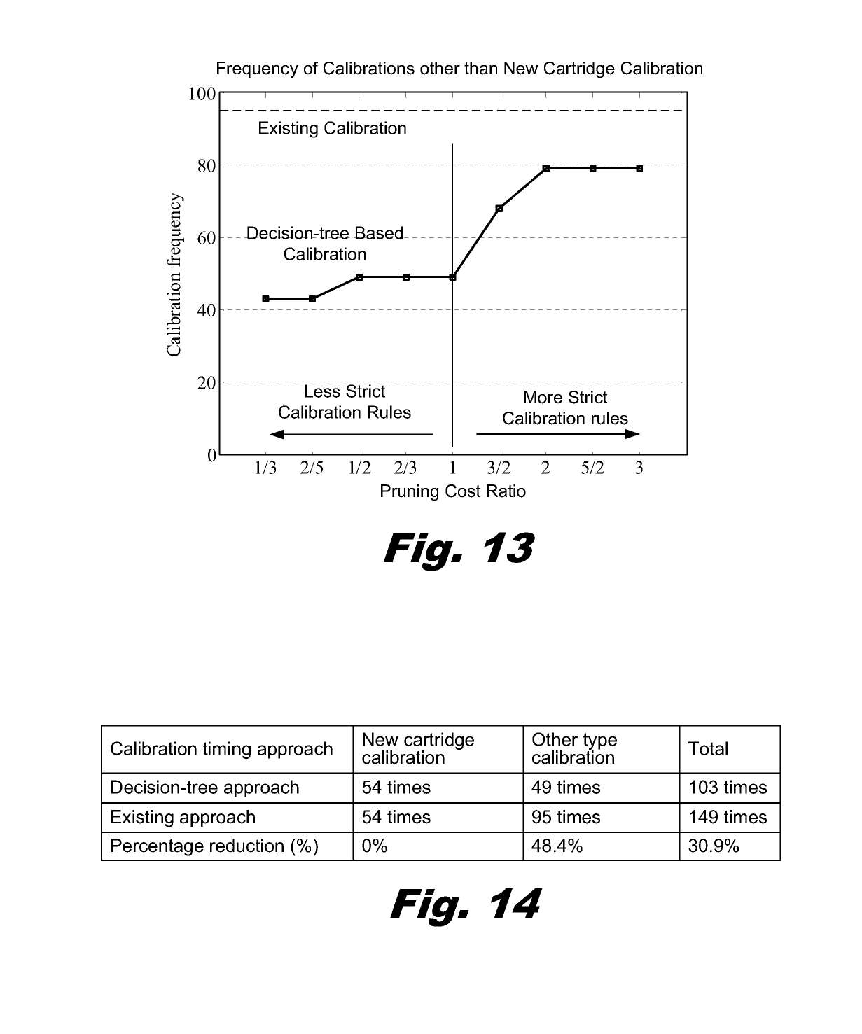

The calibration events from the simulation are categorized into two—new cartridge calibration and other types of calibration. This is because new cartridge calibration is inevitable for purposes of color plane registration and should not be included in the comparison. FIG. 13 shows the frequency of calibrations other than new cartridge calibrations as a function of cost ratio. The frequency of historical calibrations is consistently at a 95 level. The historical calibrations do not change as a function of cost ratio because the historical calibrations do not include decision-tree-base calibrations that are structurally dependent on cost ratios. As described above, the historical calibrations occurred whenever any cartridge is consumed for 10% in their CLR since a previous calibration. However, the frequency of decision-tree based calibrations varies significantly as a function of cost ratio. As discussed above the cost ratio is defined as the ratio of false positive errors over false negative errors. When the cost ratio is less than 1, the decision trees are biased toward making more false negative results. Consequently, the rules dictating calibration are less strict and calibration occurs less frequently. At cost ratios greater than 1, the decision trees are biased toward more false positive results resulting in decision trees with more strict rules dictating more frequent calibration.

FIG. 13 shows that with a pruning cost ratio of 1, the decision-tree based approach can save 48.4% of the other types of calibration while maintaining the tone consistency of the electrophotographic printer. These results are tabulated in the table of FIG. 14. FIG. 14 shows that there is no reduction in the number of calibrations for when new printer cartridges are inserted into a printer. However, the decision-tree based approach reduces the number of calibration events that occur after a printer cartridge is inserted into a printer by approximately half. Overall, the decision-tree based approach reduces the number of calibration events by approximately a third. For pruning cost ratios that are less than 1, the number of decision-tree based calibrations would be even less.

### CONCLUSION

Traditional preventive calibration strategy can result in waste in consumables and interruption to print jobs to calibrate the printer. This motivates using a knowledge based approach to reduce calibration frequency for color electrophotographic printers while maintaining desirable tone consistency. In the decision-tree based approach described above, experiments are designed to collect tone measurements under various operating conditions. Decision trees are developed with these measurements using machine learning techniques. The decision trees can be adjusted using a cost based pruning process to provide a tradeoff between color consistency and consumable economy. The effectiveness of the decision-tree based calibration timing determination method is verified with historic data. Simulation shows that this decision-tree based method can reduce 30.9% of the total calibration for an office printer while maintaining tone consistency within a desired range.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for making a tone consistency calibration timing decision comprises:
measuring, with sensors and in conjunction with a first tone consistency calibration, a first state of a printer;
measuring a second state of the printer with the sensors;
determining, using a machine learning classification implemented by a computer processor, if changes between the first state and the second state justify a second tone consistency calibration; and
if the changes between the first state and second state indicate performing the second tone consistency calibration, then performing the second tone consistency calibration.

2. The method of claim 1, in which the first tone consistency calibration comprises an initial calibration triggered by insertion of a new print cartridge.

3. The method of claim 1, in which the first state and second state comprise a temperature and a relative humidity.

4. The method of claim 3, in which the temperature and relative humidity are measured by on-board sensors that measure a temperature and relative humidity inside the printer.

5. The method of claim 1, in which the printer is one of a: dry toner electrophotographic printer, a liquid electrophotographic printer, or an ink-jet printer.

6. The method of claim 1, in which performing the second tone consistency calibration comprises adjusting a developer bias voltage level.

7. The method of claim 1, further comprising, if output from the decision tree indicates the changes between the first state and second state do not justify a second tone consistency calibration, then re-measuring the second state of the printer at later time.

8. The method of claim 1, in which measuring the second state of the printer comprises measuring the state of the printer at a later time during operation of the printer.

9. The method of claim 8, in which the later time comprises fixed time intervals.

10. The method of claim 1, further comprising waiting until the printer completes a current print job before performing the second tone consistency calibration.

11. The method of claim 1, in which the machine learning classification is a pruned decision tree implemented by the computer processor.

12. The method of claim 11, in which determining if changes between the first state and the second state justify a second tone consistency calibration comprises inputting the second state into the decision-tree implemented by the computer processor.

13. The method of claim 11, in which determining if changes between the first state and second state justify a second tone consistency calibration comprises applying parameters of the second state to a root node in the decision tree and moving through internal nodes to a final node, the final node comprising a binary calibration decision.

14. The method of claim 11, further comprising creating the pruned decision tree by:
measuring tone changes of similar printers over a range of operating conditions;
creating a training sample;
using the training sample to generate an unpruned decision tree;
selecting a cost parameter;
pruning the unpruned decision tree using the cost parameter to form the pruned decision tree; and
validating the pruned decision tree against predetermined criteria.

15. The method of claim 14, in which validating the pruned decision tree against predetermined criteria comprises inputting, into the pruned decision tree, empirical tone consistency data that was not used in generating the first decision tree.

16. The method of claim 14, in which the cost parameter is a cost ratio comprising a ratio between false positives output by the pruned decision tree and false negatives output by the pruned decision tree.

17. A method for making a decision-tree based tone consistency calibration timing decision comprises:
measuring, with on-board sensors and in conjunction with a first tone consistency calibration, a first state of a printer, the first state comprising at least a temperature parameter and a relative humidity parameter;
measuring a second state of the printer with the sensors;
determining, with a computer processor, if changes between the first state and second state justify a second tone consistency calibration by applying the temperature parameter and relative humidity parameter to a root node in a pruned decision tree and moving through internal nodes to a final node of the pruned decision tree, the final node comprising a binary calibration decision; and
if the binary calibration decision indicates a second tone consistency calibration should be performed, then:
waiting until the printer completes a current print job; and
performing the second tone consistency calibration, the second tone consistency calibration comprising adjusting a developer voltage level; and
if the binary calibration decision output from the decision tree indicates the changes between the first state and second state do not justify a second tone consistency calibration, then re-measuring the second state of the printer at later time.

18. A printer comprising:
at least one sensor for measuring a state of the printer; and
a decision-tree based calibration module, in which the calibration module is to accept data values from the sensor, apply the data values to a decision tree, and output a binary tone consistency calibration decision.

19. The printer of claim 18, further comprising a controller for accepting the calibration decision from the calibration module, in which, if the decision indicates a calibration should be performed, then the controller directs the printer to perform a calibration.

20. The printer of claim 18, further comprising:
an electrophotographic drum;
toner deposited on the electrophotographic drum to form an image, in which, in response to receiving a calibration decision from the calibration module, a predetermined calibration pattern is formed by creating a image of toner on the electrophotographic drum; and
an optical sensor for measuring tone values of the calibration pattern, in which the controller accepts output from the optical sensor and adjusts a developer voltage level achieve a target tone.
